(19) United States
(12) Patent Application Publication
(10) Pub. No.: US 2026/0116558 A1
(43) Pub. Date: Apr. 30, 2026

(54) AIRCRAFT PROPULSION UNIT COMPRISING A MAIN LINK FOR AN ENGINE MOUNT, IN ADDITION TO TWO SAFETY LINKS IN PARALLEL, WHICH ARE CONNECTED TO A FRONT TRANSVERSE REINFORCEMENT OF A PRIMARY STRUCTURE OF A PYLON

(71) Applicant: Airbus Operations SAS, TOULOUSE (FR)

(72) Inventors: Michael BERJOT, TOULOUSE (FR); Rémi LANSIAUX, TOULOUSE (FR); Jean-Baptiste VIGNES, TOULOUSE (FR)

(21) Appl. No.: 18/766,159

(22) Filed: Jul. 8, 2024

(30) Foreign Application Priority Data
Jul. 10, 2023 (FR) FR2307334

(51) Int. Cl. B64D 27/40; F01D 25/28

(52) U.S. Cl. CPC B64D 27/402; F01D 25/28

(57) ABSTRACT

Aircraft propulsion unit comprising a main link for an engine mount, in addition to two safety links in parallel, which are connected to a front transverse reinforcement of a primary structure of a pylon. A front engine mount, connecting a primary structure of a pylon and an engine, comprises a main link which is positioned between a clevis of the front transverse reinforcement and a clevis of the engine, two safety links which are arranged on either side of the main link and about which the clevises are arranged, and a reinforcing connecting pin and an engine connecting pin connecting the main link and the safety links to the front transverse reinforcement and to the engine.

### CROSS-REFERENCES TO RELATED APPLICATIONS

This application claims the benefit of French Patent Application Number 2307334 filed on Jul. 10, 2023, the entire disclosure of which is incorporated herein by way of reference.

### FIELD OF THE INVENTION

The present invention relates to an aircraft propulsion unit comprising a front engine mount comprising a main link, in addition to two safety links arranged in parallel with said main link, which are connected to a front transverse reinforcement of a primary structure of a pylon and to an aircraft engine. The present invention also relates to an aircraft comprising at least one such propulsion unit.

### BACKGROUND OF THE INVENTION

According to one embodiment, which can be seen in FIGS. 1 and 2, an aircraft 10 comprises wings 12 and at least one propulsion unit 14 which is positioned below each of the wings 12. The propulsion unit 14 comprises a pylon 16 which is fixed below the wing 12 and an engine 18 which is fixed below the pylon 16. More specifically, the pylon 16 comprises a primary structure 20 which is connected to the engine 18 by an engine mount 22 and to the wing 12 by a wing mount 24.

Conventionally, X refers to the longitudinal direction of the pylon 16, this direction X being parallel to the axis of rotation A18 of the engine 18 and to a longitudinal axis of the aircraft 10. On the other hand, Y refers to the transverse direction of the pylon 16 which is horizontal when the aircraft 10 is on the ground and perpendicular to the axis of rotation A18 of the engine 18, and Z refers to the vertical direction or vertical height when the aircraft 10 is on the ground and perpendicular to the axis of rotation A18 of the engine 18, these three directions X, Y and Z being at right-hand-angles to one another.

On the other hand, the terms “front” and “rear” are to be considered relative to a forward direction of travel of the aircraft 10 during the operation of the engine 18 (direction of flow of the gases, the front corresponding to the intake of the gases (air) into the engine and the rear corresponding to the exhaust of the gases (combustion gases)), this direction being shown schematically by the arrow A. The terms “port” and “starboard” are also to be considered relative to the forward direction of travel A of the aircraft 10 and relative to the longitudinal direction X.

The engine mount 22 comprises a front engine mount 26, a rear engine mount 28 and a pair of thrust rods 30 ensuring the take-up of thrust forces.

According to a configuration which can be seen in FIG. 3, the primary structure 20 of the pylon 16 comprises upper and lower spars 20.1, right-hand and left-hand side panels 20.2, in addition to a plurality of transverse reinforcements 20.3 connecting the upper and lower spars 20.1, in addition to right-hand and left-hand side panels 20.2. A front transverse reinforcement 20.3 is positioned at the front of the primary structure 20 of the pylon and extends at least partially on the lower spar 20.1. This front transverse reinforcement 20.3 has a bearing surface to fix the front engine mount 26, which is positioned in a horizontal plane, below said front transverse reinforcement.

The front engine mount 26 comprises:
a transverse beam 32 which is positioned below the primary structure 20, below the front reinforcement, and which is connected to the primary structure 20 by vertical connecting elements (not visible in FIG. 3) and to the engine 18 by a safety connecting pin 36,
a first link 38 which is connected to the engine 18 by a first engine connecting pin 40 and which is connected to the transverse beam 32 by a first beam connecting pin 42,
a second link 44 which is connected to the engine 16 by a second engine connecting pin 46 and which is connected to the transverse beam 32 by a second beam connecting pin 48.

For each beam connecting pin 42, 48, the transverse beam 32 comprises a clevis having two flanges 32.1, 32.2, the first or second link 38, 44 being positioned therebetween.

For each engine connecting pin 40, 46, the engine casing (not shown in FIG. 3) comprises a clevis having two flanges, the first or second link 38, 44 being positioned therebetween.

For the safety connecting pin 36, the transverse beam 32 comprises a clevis having a flange 36.1 which is positioned between two flanges of a clevis (not visible in FIG. 3) of the engine casing.

Such a front engine mount 26 has a so-called “fail safe” interface which is disconnected from the primary force paths. In particular, the links 38, 44 correspond to the primary force paths and, in the nominal configuration, make it possible to ensure the take-up of forces, while the safety connecting pin 36 corresponds to a stand-by force path, a so-called safety force path, and makes it possible to ensure the take-up of forces in the case of a degraded configuration of one of the links 38, 44 or of one of the clevises 32.1, 32.2 of the transverse beam 32, or of one of the clevises of the engine casing.

With such a front engine mount 26, it is thus necessary to provide a stand-by clevis on the engine casing and on the front engine mount (the safety connecting pin 36). However, the integration of these stand-by interfaces renders the design of the engine casing more complex, in addition to that of the front engine mounts.

Moreover, the distribution of forces can be significantly modified between the nominal and degraded configurations of the front engine mount, which may make the dimensioning of the parts complex.

Thus there is a need for a front engine mount having a so-called “fail safe” interface which makes it possible to limit the stand-by interfaces and to control the force paths in the structure more effectively.

### SUMMARY OF THE INVENTION

The present invention relates to an aircraft propulsion unit comprising a primary structure of a pylon, an engine and a front engine mount connecting the primary structure and the engine, the primary structure comprising upper and lower spars, right-hand and left-hand side panels, in addition to a front transverse reinforcement, the front transverse reinforcement comprising, for each right-hand and left-hand side panel, a first clevis protruding relative to said side panel and having two first flanges, each first flange having a first bore, and the engine comprising at least one second clevis having two second flanges, each second flange having a second bore.

According to the invention, the front engine mount comprises:
a first link having third and fourth bores and being positioned between the first flanges of the first clevis of the front transverse reinforcement and between the second flanges of the second clevis of the engine,
second and third safety links, each having fifth and sixth bores, the first clevis of the front transverse reinforcement and the second clevis of the engine being positioned between the second and third safety links,
a first reinforcing connecting pin which is inserted into the first, third and fifth bores, and
a first engine connecting pin which is inserted into the second, fourth and sixth bores.

The propulsion unit according to the invention makes it possible to minimize the number of stand-by interfaces by eliminating the stand-by clevises on the engine casing and on the front engine mount, and thus to simplify the design of the engine casing and the front engine mount. This propulsion unit also makes it possible to preserve the distribution of forces between the nominal configuration and the degraded configuration of the front engine mount, which simplifies the dimensioning of the parts. In particular, the presence of the safety links makes it possible to ensure the continuity of the passage of forces in all conditions.

According to a further feature, the engine comprises a third clevis having two third flanges, each third flange having a seventh bore, the second and third safety links being positioned between the third flanges of the third clevis of the engine.

Advantageously, the presence of the third clevis of the engine makes it possible to ensure the continuity of the passage of forces in all conditions (nominal or degraded condition of the second clevis of the engine).

According to a further feature, the second and third safety links are separated from the third clevis of the engine by a first clearance.

Advantageously, this first clearance makes it possible to meet the manufacturing tolerances, in addition to displacements due to the articulation of the joint between the front transverse reinforcement and the engine in a degraded situation. This clearance also enables a rotation of the third clevis of the engine relative to the second and third links.

According to a further feature, the first engine connecting pin is inserted into the sixth bores of the second and third safety links with a second clearance. This second clearance makes it possible to have the second and third stand-by safety links. According to a further feature, the second and third safety links are separated from the second clevis of the engine by a third clearance.

Advantageously, this third clearance makes it possible to meet the manufacturing tolerances, in addition to displacements due to the articulation of the joint between the front transverse reinforcement and the engine in the nominal situation. This clearance also enables a rotation of the second clevis of the engine relative to the first link.

According to a further feature, the front engine mount comprises, for each first flange of the first clevis of the front transverse reinforcement, a reinforcing ring arranged in the first bore.

According to a further feature, the first reinforcing connecting pin has an eighth bore and the propulsion unit comprises a second safety reinforcing connecting pin which is inserted into the eighth bore of the first reinforcing connecting pin.

Advantageously the presence of a double reinforcing connecting pin makes it possible to ensure the continuity of the passage of forces in all conditions (nominal or degraded conditions of the first reinforcing connecting pin).

According to a further feature, the first engine connecting pin has a ninth bore and the propulsion unit comprises a second safety engine connecting pin which is inserted into the ninth bore of the first engine connecting pin.

Advantageously the presence of a double engine connecting pin makes it possible to ensure the continuity of the passage of forces in all conditions (nominal or degraded conditions of the first engine connecting pin).

A further subject of the present invention is an aircraft comprising at least one propulsion unit according to the invention.

### BRIEF DESCRIPTION OF THE DRAWINGS

Further features and advantages will be found in the following description of the invention, the description being provided solely by way of example with reference to the accompanying drawings, in which:

FIG. 1 is a side view of an aircraft,

FIG. 2 is a side view of an aircraft propulsion unit without the nacelle,

FIG. 3 is a perspective view of a front engine mount illustrating an embodiment of the prior art,

FIG. 4 is a perspective view of a front engine mount illustrating an embodiment of the invention,

FIG. 5 is a front view of a front engine mount illustrating an embodiment of the invention,

FIG. 6 is a perspective view of a section of a front engine mount illustrating an embodiment of the invention,

FIG. 7 is a sectional view of a front engine mount illustrating an embodiment of the invention, and

FIG. 8 is a sectional view of a front engine mount illustrating a further embodiment of the invention.

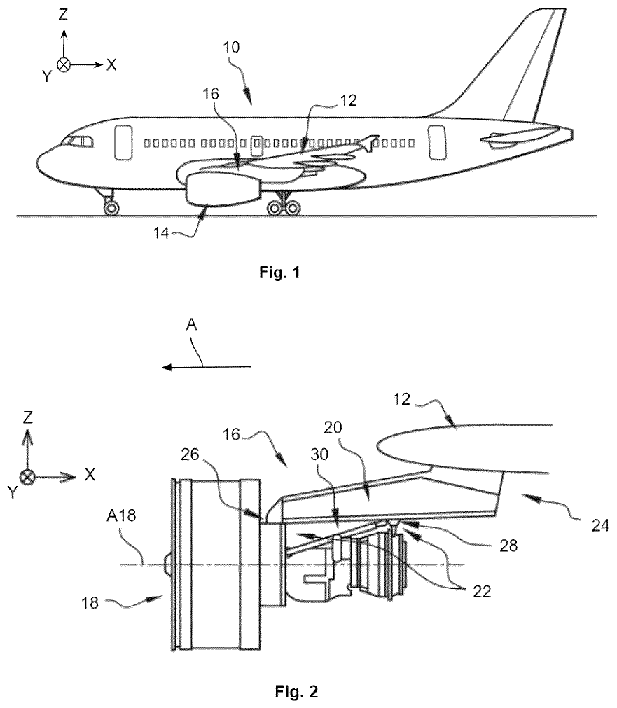

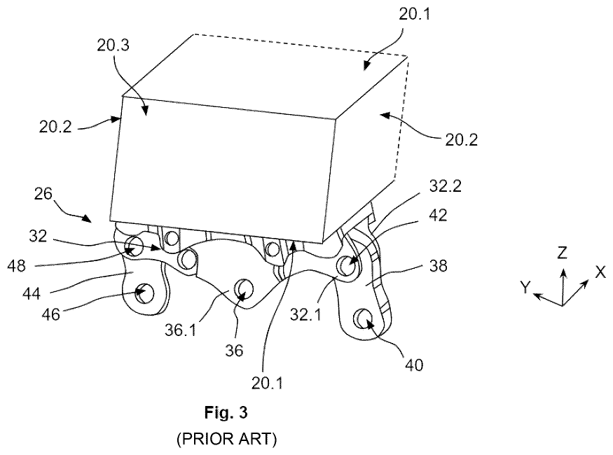

### DETAILED DESCRIPTION OF THE PREFERRED EMBODIMENTS

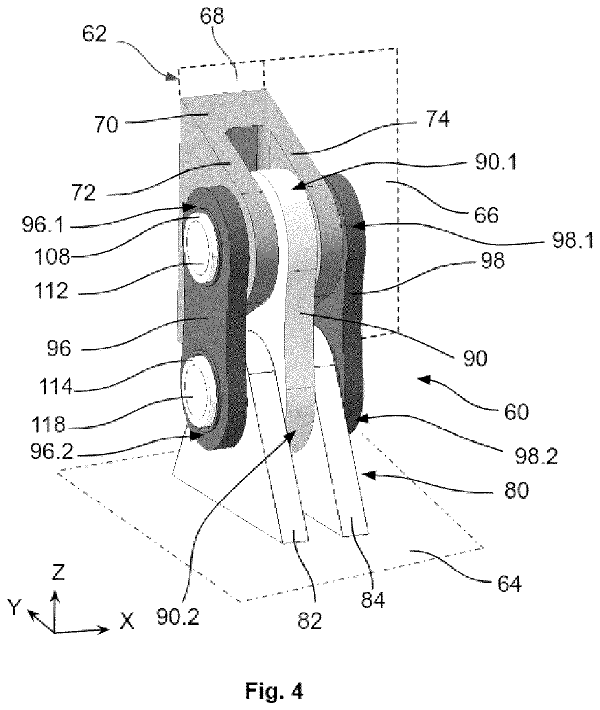

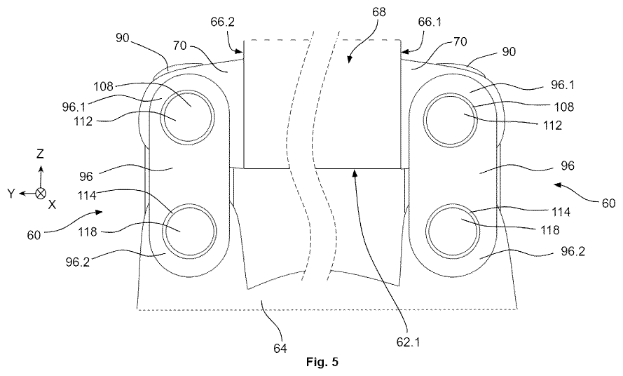

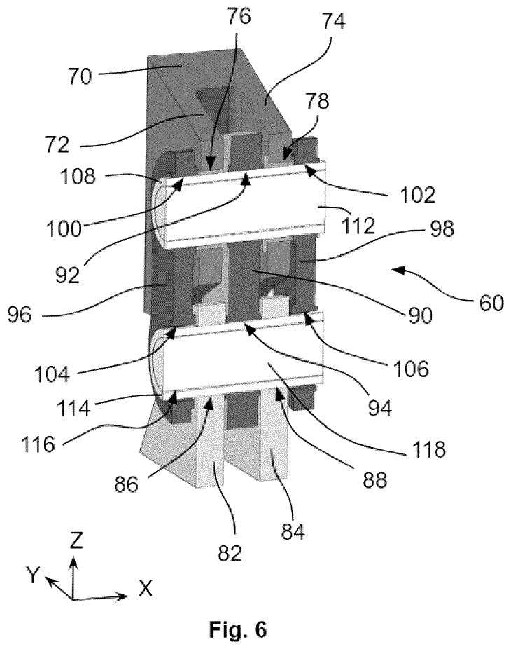

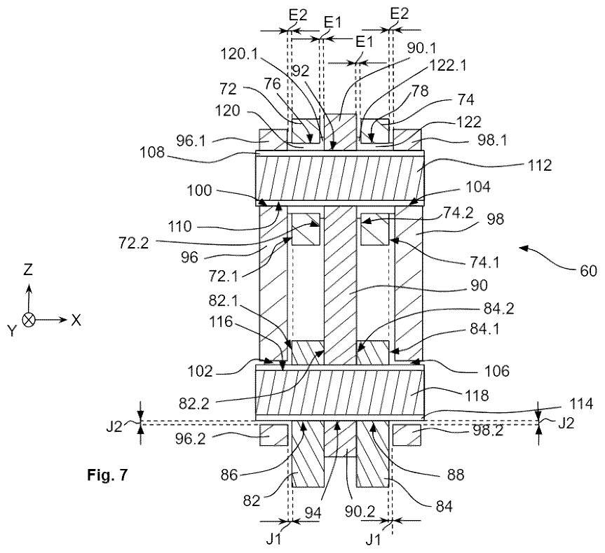

A front engine mount 60 of a propulsion unit connecting a primary structure 62 of an aircraft pylon and an engine 64 is shown in FIGS. 4 to 7. In these figures, only a part of the casing of the engine 64 and of the primary structure 62 are shown. At least one propulsion unit of an aircraft is provided with such a front engine mount 60.

The primary structure 62 comprises an upper spar (not shown in FIGS. 4 to 7) and a lower spar 62.1, a right-hand side panel 66.1 and a left-hand side panel 66.2, in addition to a front transverse reinforcement 68. The right-hand and left-hand side panels 66.1, 66.2 extend in planes parallel to the plane X-Z. The front transverse reinforcement 68 extends in a plane parallel to the plane Y-Z. The front transverse reinforcement 68 comprises, for each right-hand and left-hand side panel 66.1, 66.2, a female clevis 70 protruding relative to said right-hand or left-hand side panel 66.1, 66.2. Thus the clevis 70 extends in a plane parallel to the plane Y-Z and thus transversely to the right-hand and left-hand side panels 66.1, 66.2. The clevis 70 has two flanges 72, 74 which each have a bore 76, 78, the axis thereof being parallel to the longitudinal direction X.

The engine 64 comprises at least one female clevis 80 which protrudes in the direction of the primary structure 62 and which has two flanges 82, 84. The clevis 80 extends in a plane parallel to the plane Y-Z. Each flange 82, 84 has a bore 86, 88, the axis thereof being parallel to the longitudinal direction X.

The front engine mount 60 comprises a link 90, the so-called main or central link, which extends in a plane parallel to the plane Y-Z and which has a first bore 92 at its first end 90.1 and a second bore 94 at its second end 90.2. The bores 92, 94 extend along an axis parallel to the longitudinal direction X. The first end 90.1 of the main link 90 is positioned between the flanges 72, 74 of the clevis 70 of the front transverse reinforcement 68, and the second end 90.2 of the main link 90 is positioned between the flanges 82, 84 of the clevis 80 of the engine 64. The clevis 70 of the front transverse reinforcement 68 and the clevis 80 of the engine 64 are thus substantially aligned, so that the flanges 72, 74 of the clevis 70 and the flanges 82, 84 of the clevis 80 are arranged on either side of the main link 90.

The front engine mount 60 also comprises two links 96, 98, so-called safety or lateral links. Each safety link 96, 98 extends in a plane parallel to the plane Y-Z and has a first bore 100, 102 at its first end 96.1, 98.1 and a second bore 104, 106 at its second end 96.2, 98.2. The bores 100, 102, 104, 106 extend along an axis parallel to the longitudinal direction X. The clevis 70, and in particular the flanges 72, 74, of the front transverse reinforcement 68 are positioned between the first end 96.1 of the safety link 96 and the first end 98.1 of the safety link 98. The clevis 80, and in particular the flanges 82, 84 of the engine 64, are positioned between the second end 96.2 of the safety link 96 and the second end 98.2 of the safety link 98. In other words, the safety links 96, 98 are arranged on either side of the clevis 70 of the front transverse reinforcement 68 and the clevis 80 of the engine 64. Thus the clevis 70 of the front transverse reinforcement 68 is positioned between the first ends 96.1, 98.1 of the safety links 96, 98 and the clevis 80 of the engine 64 is positioned between the second ends 96.2, 98.2 of the safety links 96, 98.

The safety links 96, 98 and the main link 90 are thus arranged in parallel relative to one another, the main link 90 being arranged between the safety links 96, 98. The main link 90 has longitudinal dimensions (in the longitudinal direction X), transverse dimensions (in the transverse direction Y) and vertical dimensions (in the vertical direction Z) which are greater than the longitudinal, transverse and vertical dimensions of the safety links 96, 98. The safety links 96, 98 are substantially identical.

The front engine mount 60 comprises a first reinforcing connecting pin 108, the so-called main reinforcing connecting pin, which has a bore 110, the axis thereof being parallel to the longitudinal direction X. The first reinforcing connecting pin 108 extends along an axis parallel to the longitudinal direction X. The first reinforcing connecting pin 108 is arranged in the bore 100 of the safety link 96, in the bore 76 of the flange 72 of the clevis 70 of the front transverse reinforcement 68, in the bore 92 of the main link 90, in the bore 78 of the flange 74 of the clevis 70, and in the bore 104 of the safety link 98. The bores 100, 76, 92, 78, 104 are coaxial. Thus the first reinforcing connecting pin 108 makes it possible to connect the front engine mount 60 to the front transverse reinforcement 68. The front engine mount 60 comprises a second safety reinforcing connecting pin 112 which is arranged in the bore 110 of the first reinforcing connecting pin 108. Thus the first reinforcing connecting pin 108 and the second safety reinforcing connecting pin 112 form a double reinforcing connecting pin between the front transverse reinforcement 68 and the front engine mount 60. The second safety reinforcing connecting pin 112 makes it possible to ensure the continuity of the passage of forces in all conditions, even in the degraded situation of the first reinforcing connecting pin 108.

The external diameter (radial dimension relative to the longitudinal direction X) of the second safety reinforcing connecting pin 112 is substantially equal to the diameter of the bore 110 of the first reinforcing connecting pin 108, so that the safety reinforcing connecting pin 112 is inserted by force into the bore 110 of the main reinforcing connecting pin 108.

The external diameter of the first reinforcing connecting pin 108 is substantially equal to the diameter of the bore 100, 104 of the safety link 96, 98, in addition to the diameter of the bore 92 of the main link 90. A rotation of the main link 90 or the safety links 96, 98 about the first reinforcing connecting pin 108 is permitted. The main link 90 and the safety links 96, 98 are mounted on the first reinforcing connecting pin 108 with a tight fit.

The front engine mount 60 comprises, for each flange 72, 74, of the clevis 70 of the front transverse reinforcement 68, a reinforcing ring 120, 122 comprising a hollow body which is at least partially positioned in the bore 76, 78 of said flange 72, 74. The external diameter of the body of the reinforcing ring 120, 122 is substantially equal to the diameter of the bore 76, 78 of the flange 72, 74 of the clevis 70 of the front transverse reinforcement 68, so that the reinforcing ring 120, 122 is inserted by force into the bore 76, 78 of the flange 72, 74 of the clevis 70. The external diameter of the first reinforcing connecting pin 108 is substantially equal to the internal diameter of the body of the reinforcing ring 120, 122.

The front engine mount 60 comprises a first engine connecting pin 114, the so-called main engine connecting pin, which has a bore 116, the axis thereof being parallel to the longitudinal direction X. The first engine connecting pin 114 extends along an axis parallel to the longitudinal direction X. The first engine connecting pin 114 is arranged in the bore 102 of the safety link 96, in the bore 86 of the flange 82 of the clevis 80 of the engine 64, in the bore 94 of the main link 90, in the bore 88 of the flange 84 of the clevis 80, and in the bore 106 of the safety link 98. The bores 102, 86, 94, 88, 106 are coaxial. Thus the first engine connecting pin 114 makes it possible to connect the front engine mount 60 to the engine 64.

The front engine mount 60 comprises a second safety engine connecting pin 118 which is arranged in the bore 116 of the first engine connecting pin 114. Thus the first engine connecting pin 114 and the second safety engine connecting pin 118 form a double reinforcing connecting pin between the front transverse reinforcement 68 and the front engine mount 60. The second safety engine connecting pin 118 makes it possible to ensure the continuity of the passage of forces in all conditions, even in the case of a degraded situation of the first engine connecting pin 114.

The external diameter of the second safety engine connecting pin 118 is substantially equal to the diameter of the bore 116 of the first engine connecting pin 114, so that the safety engine connecting pin 118 is inserted by force into the bore 116 of the main engine connecting pin 114.

Thus the main link 90 is connected to the engine 64 by the first engine connecting pin 114 and to the front transverse reinforcement 68 by the first reinforcing connecting pin 108, the main link 90 being positioned between the flanges 72, 74 of the clevis 70 of the front transverse reinforcement 68 and between the flanges 82, 84 of the clevis 80 of the engine 64. The safety links 96, 98 are connected to the engine 64 by the first engine connecting pin 114 and to the front transverse reinforcement 68 by the first reinforcing connecting pin 108, the clevis 70 of the front transverse reinforcement 68 and the clevis 80 of the engine 64 being positioned between the safety links 96, 98.

The external faces 72.1, 74.1 of the clevis 70, i.e. the external face 72.1 of the flange 72 and the external face 74.1 of the flange 74 (in contrast to the internal faces 72.2, 74.2 of the flanges 72, 74 which oppose one another) are substantially aligned in the longitudinal direction X with the external faces 82.1, 84.1 of the clevis 80, i.e., the external face 82.1 of the flange 82 and the external face 84.1 of the flange 84 (in contrast to the internal faces 82.2, 84.2 of the flanges 82, 84 which oppose one another). The longitudinal dimension of the flanges 72, 74 of the clevis 70 of the front transverse reinforcement 68 is less than the longitudinal dimension of the flanges 82, 84 of the clevis 80 of the engine 64. Thus the distance in the longitudinal direction X between the flanges 72, 74 of the clevis 70 (distance between the internal faces 72.2, 74.2) is greater than the distance between the flanges 82, 84 of the clevis 80 (distance between the internal faces 82.2, 84.2).

No clearance is produced between the main link 90 and the flanges 82, 84 of the clevis 80 of the engine 64 in the region of the second end 90.2 of the main link 90. In other words, the longitudinal dimension of the main link 90 is substantially equal to the distance in the longitudinal direction X between the flanges 82, 84 of the clevis 80 (distance between the internal faces 82.2, 84.2).

A space E1 is present between the main link 90 and each internal face 72.2, 74.2 of the flange 72, 74 of the clevis 70 of the front transverse reinforcement 68 in the region of the first end 90.1 of the main link 90. The reinforcing ring 120, 122 comprises a radial protuberance 120.1, 122.1 which has a greater diameter than the external diameter of the body of the reinforcing ring 120, 122 and which extends from the body of the reinforcing ring 120, 122 between the main link 90 and the flanges 72, 74 of the clevis 70. The longitudinal dimension of the radial protuberance 120.1, 122.1 is substantially equal to the space E1. Thus the space E1 between the main link 90 and the clevis 70 is filled by the radial protuberance 120.1, 122.1 of the reinforcing ring 120, 122.

For each safety link 96, 98, a space E2 is present between the safety link 96, 98 and the external face 72.1, 74.1 of the flange 72, 74 of the clevis 70 of the front transverse reinforcement 68 in the region of the first end 96.1, 98.1 of the safety link 96, 98. The body of the reinforcing ring 120, 122 extends beyond the bore 76, 78 in the direction of the safety link 96, 98 and, in particular, in the space E2. Thus the space E2 between the safety link 96, 98 and the clevis 70 is filled by the body of the reinforcing ring 120, 122.

For each safety link 96, 98, a clearance J1 is present between the safety link 96, 98 and the external face 82.1, 84.1 of the flange 82, 84 of the clevis 80 of the engine 64 in the region of the second end 96.2, 98.2 of the safety link 96, 98. The clearance J1 is configured to enable the manufacturing tolerances to be met, in addition to displacements due to the articulation of the joint between the front transverse reinforcement 68 and the engine 64, in the nominal situation. The clearance J1 is configured to be the lowest possible in order to minimize the flexion of the flanges 82, 84 of the clevis 80. The clearance J1 advantageously enables a rotation of the clevis 80 of the engine 64 relative to the main link 90.

The main link 90 is mounted on the first engine connecting pin 114 with a tight fit. For each safety link 96, 98, a clearance J2 is present between the bore 102, 106 of the safety link 96, 98 and the first engine connecting pin 114 in the region of the second end 96.2, 98.2 of the safety link 96, 98. In other words, the first engine connecting pin 114 is inserted into the bores 102, 106 of the safety links 96, 98 with a clearance J2. The clearance J2 is configured to be filled in the case of a degraded configuration. In other words, the safety links 96, 98 are mounted on the first reinforcing connecting pin 108 with a tight fit and on the first engine connecting pin 114 with the clearance J2. In the case of malfunction, the safety link(s) 96, 98 or the first engine connecting pin 114 is (are) displaced to move the wall of the bore 100, 104 of the safety link 96, 98 against the first engine connecting pin 114.

In the nominal configuration, the forces are transmitted from the clevis 80 of the engine 64 to the main link 90, and then to the clevis 70 of the front transverse reinforcement 68. In the nominal configuration, the safety links 96, 98 are “on stand-by” and do not permit the take-up of forces. More specifically, the safety links 96, 98 are separated from the first engine connecting pin 114 by the clearance J2 which is not zero.

In a first degraded configuration where the main link 90 is defective, the forces will be transmitted from the clevis 80 of the engine 64 to the safety links 96, 98, and then to the clevis 70 of the front transverse reinforcement 68. The clearance J2 which is present in the nominal configuration between the safety links 96, 98 and the first engine connecting pin 114 is filled up in this degraded configuration. More specifically, if the main link 90 is defective, this main link no longer permits the transmission of forces to be ensured in the direction of the front transverse reinforcement 68. The engine 64 which was held on the front transverse reinforcement 68 by means of the clevis 80 of the engine 64, the main link 90 and the clevis 70 of the front transverse reinforcement 68 in the nominal configuration, will now be held on the front transverse reinforcement 68 by means of the clevis 80 of the engine 64, the safety links 96, 98 and the clevis 70 of the front transverse reinforcement 68 in this degraded configuration. In this degraded configuration, the first engine connecting pin 114 rests in the bore 102, 106 of the safety link 96, 98 so that the clearance J2 between the first engine connecting pin 114 and the safety links 96, 98 is zero.

In a second degraded configuration where a flange 82 of the clevis 80 of the engine 64 is defective, the forces are transmitted from the flange 84 of the clevis 80 of the engine 64 to the main link 90 and to the safety link 98, and then to the clevis 70 of the front transverse reinforcement 68. Similarly, in this degraded configuration the clearance J2 is zero.

In a third degraded configuration where a flange 72 of the clevis 70 of the front transverse reinforcement 68 is defective, the forces are transmitted from the clevis 80 of the engine 64 to the main link 90 and to the safety link 98, and then to the flange 74 of the clevis 70 of the front transverse reinforcement 68. Similarly, in this degraded configuration, the clearance J2 is zero.

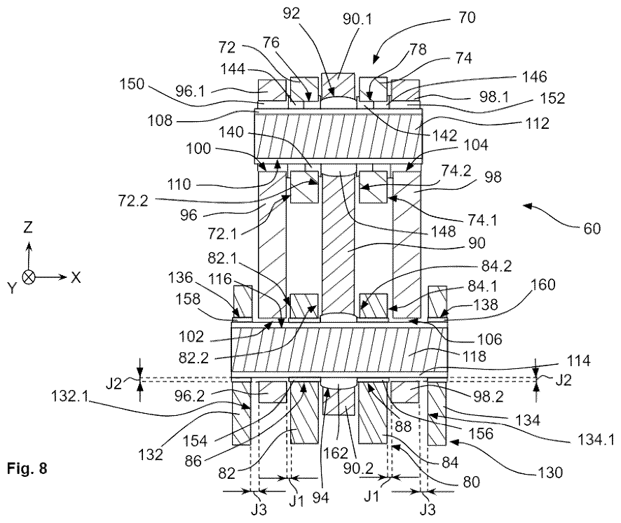

FIG. 8 shows a front engine mount according to a further embodiment. In this embodiment, the engine comprises at least the first female clevis 80, which protrudes in the direction of the primary structure of the pylon and which has two flanges 82, 84, and a second female clevis 130, which protrudes in the direction of the primary structure of the pylon and which has two flanges 132, 134. The clevises 80, 130 extend in a plane parallel to the Y-Z plane. The clevises 80, 130 are arranged in parallel with one another. Each flange 82, 84, 132, 134 has a bore 86, 88, 136, 138, the axis thereof being parallel to the longitudinal direction X. The clevis 80 is arranged between the flanges 132, 134 of the clevis 130. The bores 86, 88, 136, 138 are coaxial.

The clevis 130 of the engine, and in particular the flanges 132, 134 thereof, are positioned about the second end 96.2 of the safety link 96 and the second end 98.2 of the safety link 98. In other words, the safety links 96, 98 are arranged between the flanges 132, 134 of the clevis 130 of the engine, and about the clevis 80. Thus the clevis 70 of the front transverse reinforcement is positioned between the first ends 96.1, 98.1 of the safety links 96, 98, while the second ends 96.2, 98.2 of the safety links 96, 98 are arranged between the flange 132 of the clevis 130 and the flange 82 of the clevis 80 for the first safety link 96, and between the flange 134 of the clevis 130 and the flange 84 of the clevis 80 for the second safety link 98.

According to this embodiment, the front engine mount 60 comprises, for each flange 72, 74 of the clevis 70 of the front transverse reinforcement, a first reinforcing half-ring 140, 142 comprising a hollow body which is at least partially positioned in the bore 76, 78 of said flange 72, 74, from the internal face 72.2, 74.2 of the flange 72, 74, and a second reinforcing half-ring 144, 146 comprising a hollow body which is at least partially positioned in the bore 76, 78 of said flange 72, 74, from the external face 72.1, 74.1 of the flange 72, 74. The first and second reinforcing half-rings 140, 142, 144, 146 thus form a reinforcing ring for each bore 76, 78 of the flange 72, 74. The external diameter of the body of each reinforcing half-ring 140, 142, 144, 146 is substantially equal to the diameter of the bore 76, 78 of the flange 72, 74 of the clevis 70 of the front transverse reinforcement 68, so that each reinforcing half-ring 140, 142, 144, 146 is inserted by force into the bore 76, 78 of the flange 72, 74 of the clevis 70. The external diameter of the first reinforcing connecting pin 108 is substantially equal to the internal diameter of the body of each reinforcing half-ring 140, 142, 144, 146.

According to this embodiment, the front engine mount 60 comprises, for the main link 90, a reinforcing ring 148 which is positioned in the bore 92 of said main link 90. The external dimension of the reinforcing ring 148 is substantially equal to the dimension of the bore 92 of the main link 90, so that the reinforcing ring 148 is inserted by force into the bore 92 of the main link 90. The external diameter of the first reinforcing connecting pin 108 is substantially equal to the internal diameter of the reinforcing ring 148.

According to this embodiment, the front engine mount 60 comprises, for each safety link 96, 98, a reinforcing ring 150, 152 which is positioned in the bore 100, 104 of said safety link 96, 98. The external diameter of the reinforcing ring 150, 152 is substantially equal to the diameter of the bore 100, 104 of the safety link 96, 98, so that the reinforcing ring 150, 152 is inserted by force into the bore 100, 104 of the safety link 96, 98. The external diameter of the first reinforcing connecting pin 108 is substantially equal to the internal diameter of the reinforcing ring 150, 152.

The reinforcing ring 150 extends beyond the bore 100 of the safety link 96 in the longitudinal direction X (here in the direction of the flange 72 of the clevis 70) and the reinforcing half-ring 144 extends beyond the bore 76 of the flange 72 of the clevis 70 in a direction opposing the longitudinal direction X (here in the direction of the safety link 96). The reinforcing ring 150 and the reinforcing half-ring 144 are in abutment against one another, while a space is produced between the safety link 96 and the flange 72 of the clevis 70.

The reinforcing ring 148 extends beyond the bore 92 of the main link 90 on either side of the bore 92. The reinforcing half-ring 140 extends beyond the bore 76 of the flange 72 of the clevis 70 in the longitudinal direction X and the reinforcing half-ring 142 extends beyond the bore 78 of the flange 74 of the clevis 70 in a direction opposing the longitudinal direction X. The reinforcing ring 148 and the reinforcing half-ring 140, 142 are in abutment against one another, while a space is produced between the main link 90 and the flange 72, 74 of the clevis 70.

The reinforcing ring 152 extends beyond the bore 104 of the safety link 98 in a direction opposing the longitudinal direction X (here in the direction of the flange 74 of the clevis 70) and the reinforcing half-ring 146 extends beyond the bore 78 of the flange 74 of the clevis 70 in the longitudinal direction X (here in the direction of the safety link 98). The reinforcing ring 152 and the reinforcing half-ring 146 are in abutment against one another, while a space is produced between the safety link 98 and the flange 74 of the clevis 70.

According to this embodiment, the front engine mount 60 comprises, for each flange 82, 84, 132, 134 of the clevis 80, 130 of the engine, a reinforcing ring 154, 156, 158, 160 which is positioned in the bore 86, 88, 136, 138 of said flange 82, 84, 132, 134. The external diameter of the reinforcing ring 154, 156, 158, 160 is substantially equal to the diameter of the bore 86, 88, 136, 138 of the flange 72, 74 of the clevis 70 of the front transverse reinforcement 68, so that the reinforcing ring 154, 156, 158, 160 is inserted by force into the bore 86, 88, 136, 138 of the flange 72, 74 of the clevis 70. The external diameter of the first reinforcing connecting pin 108 is substantially equal to the internal diameter of the reinforcing ring 154, 156, 158, 160.

According to this embodiment, the front engine mount 60 comprises, for the main link 90, a reinforcing ring 162 which is positioned in the bore 94 of said main link 90. The external dimension of the reinforcing ring 162 is substantially equal to the dimension of the bore 94 of the main link 90, so that the reinforcing ring 162 is inserted by force into the bore 94 of the main link 90. The external diameter of the first reinforcing connecting pin 108 is substantially equal to the internal diameter of the reinforcing ring 162.

The reinforcing ring 162 extends beyond the bore 94 of the main link 90 on either side of the bore 94. The reinforcing ring 154 extends beyond the bore 86 of the flange 82 of the clevis 80 in the longitudinal direction X and the reinforcing ring 156 extends beyond the bore 88 of the flange 84 of the clevis 80 in a direction opposing the longitudinal direction X. The reinforcing ring 162 and the reinforcing ring 154, 156 are in abutment against one another, while a space is produced between the main link 90 and the flange 82, 84 of the clevis 80.

According to this embodiment, the external faces 72.1, 74.1 of the clevis 70 are substantially aligned in the longitudinal direction X with the external faces 82.1, 84.1 of the clevis 80; and the internal faces 72.2, 74.2 of the clevis 70 are substantially aligned in the longitudinal direction X with the internal faces 82.2, 84.2 of the clevis 80. The longitudinal dimension of the flanges 72, 74 of the clevis 70 of the front transverse reinforcement is substantially equal to the longitudinal dimension of the flanges 82, 84 of the clevis 80 of the engine. Thus the distance in the longitudinal direction X between the flanges 72, 74 of the clevis 70 is substantially equal to the distance between the flanges 82, 84 of the clevis 80.

For each safety link 96, 98, a clearance J3 is present between the safety link 96, 98 and the internal face 132.1, 134.1 of the flange 132, 134 of the clevis 130 of the engine 64 in the region of the second end 96.2, 98.2 of the safety link 96, 98. The clearance J3 is configured to enable the manufacturing tolerances to be met, in addition to displacements due to the articulation of the joint between the front transverse reinforcement 68 and the engine 64, in the degraded situation. The clearance J3 is configured to be the lowest possible in order to minimize the flexion of the flanges 132, 134 of the clevis 130. The clearance J3 advantageously enables a rotation of the clevis 130 of the engine 64 relative to the safety link 96, 98.

According to this embodiment, the first engine connecting pin 114 is arranged in the bore 136 of the flange 132 of the clevis 130, in the bore 102 of the safety link 96, in the bore 86 of the flange 82 of the clevis 80 of the engine 64, in the bore 94 of the main link 90, in the bore 88 of the flange 84 of the clevis 80, in the bore 106 of the safety link 98, and in the bore 138 of the flange 134 of the clevis 130.

According to this embodiment, in the nominal configuration, the forces are transmitted from the clevis 80 of the engine to the main link 90, and then to the clevis 70 of the front transverse reinforcement. In the nominal configuration, the safety links 96, 98 are “on stand-by” and do not permit the take-up of forces; and the clevis 130 is “on stand-by” and does not permit the take-up of forces. According to this embodiment, in a first degraded configuration where the main link 90 is defective, the forces will be transmitted from the clevises 80, 130 of the engine to the safety links 96, 98, and then to the clevis 70 of the front transverse reinforcement.

According to this embodiment, in a second degraded configuration where a flange 82 of the clevis 80 of the engine is defective, the forces are transmitted from the flange 84 of the clevis 80 and from the flange 134 of the clevis 130 of the engine to the main link 90 and to the safety link 98, and then to the clevis 70 of the front transverse reinforcement.

According to this embodiment, in a third degraded configuration where a flange 72 of the clevis 70 of the front transverse reinforcement is defective, the forces are transmitted from the clevis 80 and the flange 134 of the clevis 130 of the engine to the main link 90 and to the safety link 98, and then to the flange 74 of the clevis 70 of the front transverse reinforcement.

Whatever the embodiment, a front engine mount according to the invention has a minimal number of safety interfaces/stand-by interfaces. Moreover, the distribution of forces is preserved in this front engine mount between a nominal configuration and a degraded configuration of such a front engine mount.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. An aircraft propulsion unit comprising:
a primary structure of a pylon, an engine, and a front engine mount connecting the primary structure and the engine,
the primary structure comprising an upper spar and a lower spar, a right-hand side panel and a left-hand side panel, and a front transverse reinforcement, the front transverse reinforcement comprising, for each right-hand side panel and left-hand side panel, a first clevis protruding relative to said side panel and having two first flanges, each first flange having a first bore,
the engine comprising at least one second clevis having two second flanges, each second flange having a second bore,
the front engine mount comprising:
a first link having a third bore and a fourth bore and being positioned between the first flanges of the first clevis of the front transverse reinforcement and between the second flanges of the second clevis of the engine,
a second safety link and a third safety link, each having a fifth bore and a sixth bore, the first clevis of the front transverse reinforcement and the second clevis of the engine being positioned between the second safety link and the third safety link,
a first reinforcing connecting pin which is inserted into the first bore, the third bore, and the fifth bore, and
a first engine connecting pin which is inserted into the second bore, the fourth bore, and the sixth bore.

2. The aircraft propulsion unit according to claim 1, wherein the engine further comprises a third safety clevis having two third flanges, each third flange having a seventh bore, the second safety link and the third safety link being positioned between the third flanges of the third safety clevis of the engine.

3. The aircraft propulsion unit according to claim 2, wherein the second safety link and the third safety link are separated from the third safety clevis of the engine by a first clearance.

4. The aircraft propulsion unit according to claim 1, wherein the first engine connecting pin is inserted into the sixth bores of the second safety link and the third safety link with a second clearance.

5. The aircraft propulsion unit according to claim 1, wherein the second safety link and the third safety link are separated from the second clevis of the engine by a third clearance.

6. The aircraft propulsion unit according to claim 1, wherein the front engine mount comprises, for each first flange of the first clevis of the front transverse reinforcement, a reinforcing ring arranged in the first bore.

7. The aircraft propulsion unit according to claim 1, wherein the first reinforcing connecting pin has an eighth bore and the propulsion unit further comprises a second safety reinforcing connecting pin which is inserted into the eighth bore of the first reinforcing connecting pin.

8. The aircraft propulsion unit according to claim 1, wherein the first engine connecting pin has a ninth bore and the propulsion unit comprises a second safety engine connecting pin which is inserted into the ninth bore of the first engine connecting pin.

9. An aircraft comprising:
at least one aircraft propulsion unit according to claim 1.
